(19) United States
(12) Patent Application Publication
(10) Pub. No.: US 2005/0059305 A1
(43) Pub. Date: Mar. 17, 2005

(54) Method of forming texture on rubber piece and the product thereof

(76) Inventor: Jack Wang, Taichung Hsien (TW)

Correspondence Address: BROWDY AND NEIMARK, P.L.L.C.;624 NINTH STREET, NW, SUITE 300, WASHINGTON, DC, 20001-5303, US

(21) Appl. No.: 10/660,668

(22) Filed: Sep. 12, 2003

(51) Int. Cl. D04H 3/00; B32B 27/04

(52) U.S. Cl. 442/37; 442/50; 442/43; 442/58; 264/325

(57) ABSTRACT

A method of forming a texture on a rubber piece has the steps of A) preparing a refined rubber piece; B) attaching a meshed piece having a predetermined pattern on the rubber piece; C) heating and rolling the meshed piece and the rubber piece, and D) adding sulfur to the rubber piece for vulcanization. The meshed piece is firmly attached on the rubber piece and serves as the texture of the rubber piece.

### BACKGROUND OF THE INVENTION

1. Field of the Invention

The present invention relates generally to a rubber product, more particularly to a method of forming a texture on a rubber piece and the product thereof.

2. Description of the Related Art

Rubber pieces are applied to a variety of products, such as the golf club shaft, hokey shaft, tennis racket and the like are respectively provided with a rubber piece on the handle thereof. The rubber piece has a predetermined texture with which provides the capability of skidproof and sweat-drainage. The belt of the treadmill or the conveyor provided with a texture will increase the capability of skidproof. A conventional method of forming the texture on a rubber piece is to provide a refined rubber piece being rolled. The rubber piece is sent to two rollers on which have predetermined textures for rolling. Sulfur is added to the rolled rubber piece for vulcanization.

The conventional method does not meet the requirement of the modern market of manufacturing the rubber pieces into various patterns of textures but only fewer amounts for each product. There are at least three reasons of the conventional method not fitting for manufacture: 1) there is at least a pair of rollers for each pattern of the texture that is going to formed on the rubber pieces; 2) there are rolling process before the texture is formed, and 3) the length of the texture that would be formed on the rubber pieces is equal to the length of the circumference of the roller so that the pattern of the texture is repeated for a shorter distance. Additionally, more rollers are prepared for the various patterns of texture, more funds are needed before manufacture and they cost much in maintenance, and most of all, repeatedly replacement of the rollers on the machine will make the machine failure.

### SUMMARY OF THE INVENTION

The primary objective of the present invention is to provide a method is forming a texture on a rubber piece, which reduce the cost of manufacture.

The secondary objective of the present invention is to provide a method of forming a texture on a rubber piece, which the texture could have various patterns and the size of the pattern is not limited.

According to the objectives of the present invention, a method of forming a texture on a rubber piece comprises the steps of A) preparing a refined rubber piece; B) preparing a meshed piece having a predetermined pattern; C) preparing a machine having two rollers thereon; D) attaching the meshed piece on the rubber piece and heating and rolling the meshed piece and the rubber piece by the rollers, and E) adding sulfur to the rubber piece for vulcanization.

### BRIEF DESCRIPTION OF THE DRAWINGS

FIG. 1 is a flow chart of a first preferred embodiment of the present invention;

FIG. 2 is a perspective view of a rubber piece before the steps of the first preferred embodiment of the present invention;

FIG. 3 is a perspective view of a meshed cloth before the steps of the first preferred embodiment of the present invention;

FIG. 4 is a perspective view of a product after the steps of the first preferred embodiment of the present invention;

FIG. 5 is an enlarged sectional view of FIG. 4, and

FIG. 6 is an enlarged sectional view of a product made by the steps of a second preferred embodiment of the present invention.

### DETAILED DESCRIPTION OF THE INVENTION

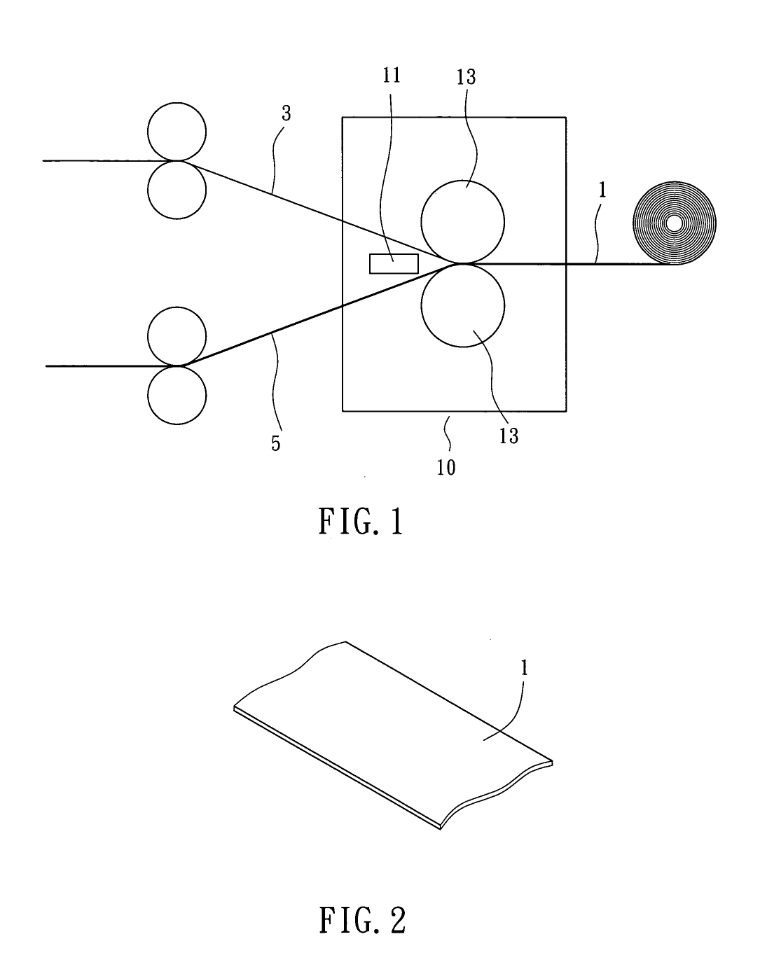

As shown in FIGS. from FIG. 1 to FIG. 3, a method of forming a texture on a rubber piece of the first preferred embodiment of the present invention has the steps of:

A) Prepare a refined rubber piece 3 having a predetermined thickness as shown in FIG. 2.

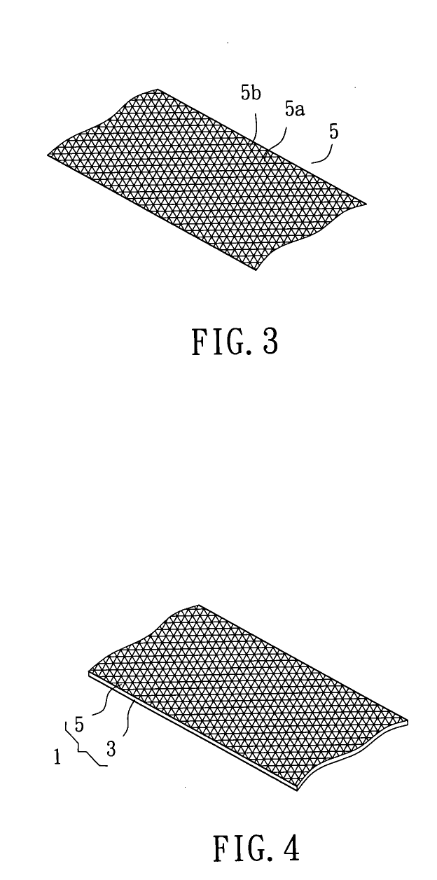

B) Prepare a meshed cloth 5 having a predetermined pattern consisted of meshes 5a and veins 5b as shown in FIG. 3.

C) Prepare a machine 10 having a heater 11 and two rollers 13, wherein the heater 11 is arranged in front of the roller 13. The heater 11 also can be provided in the rollers 13.

D) Start the heater 11 of the machine 10 to heat the rubber piece 3 and the meshed cloth 5.

E) Start the rollers 13 of the machine 10 to roll the rubber piece 3 and the meshed cloth 5. If the heater 11 is arranged in the rollers 13, the rubber piece 3 and the meshed cloth 5 are heated and rolled in the present step.

F) Add sulfur to the rubber piece after rolled for vulcanization. The end product 1 of the rubber piece 3 with a predetermined pattern of a texture is formed.

The advantage of the present invention is that the meshed cloth 5 having the pattern replaces the patterns on the rollers of the conventional method so that no replacement of the roller is needed in the present invention and there is no stop for the replacement of the rollers in the processes. Of course, there is no maintenance and failure of the machine in present invention and the cost of manufacture is therefore reduced.

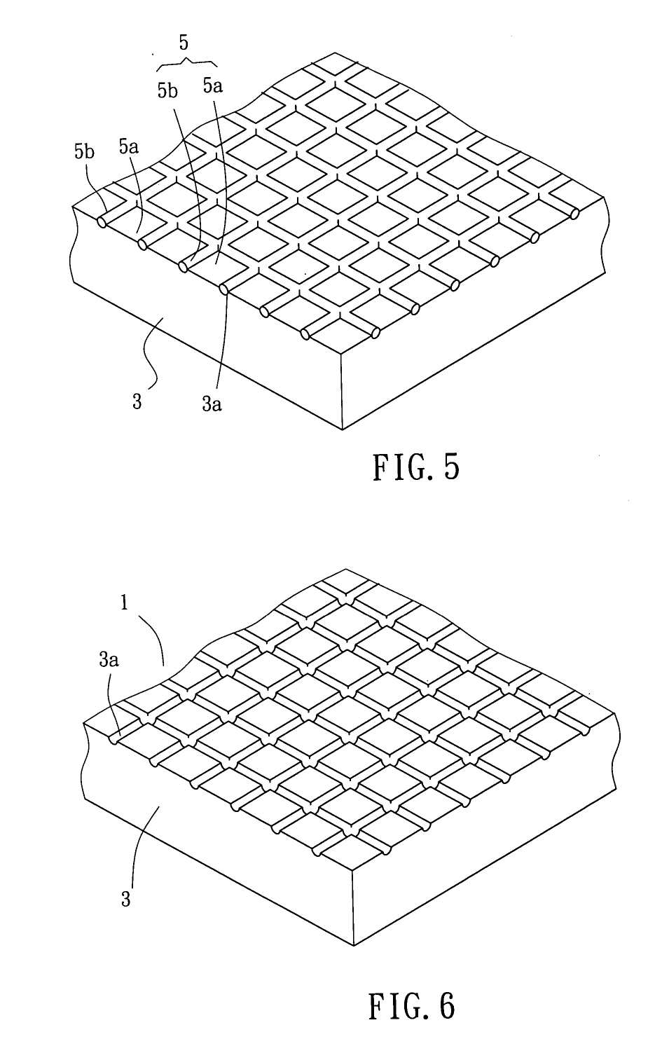

As shown in FIG. 4 and FIG. 5, the end produce 1 of the present invention is firmly attached with the meshed cloth 5 thereon to form the texture. In the heating step, the rubber piece 3 is softened and the meshed is firmly attached on the softened rubber piece 3 in the rolling step. The rubber piece 3 is deformed inwardly at where the veins 5b of the meshed cloth 5 are. The rubber piece 3, therefore, has recesses 3a thereon and the veins 5b of the meshed cloth 5 have parts thereof received in the recesses 3a and firmly fixed therein. The rubber piece 3 also has portions exposed via the meshes 5a of the meshed cloth 5. In the other words, the present invention has the rubber piece 3 to be the base and the meshed cloth 5 to be the texture. The meshed cloth 5 serves both of the texture on the surface and increase of friction because it has a material property different from the rubber piece 3.

The present invention provides the meshed cloth 5 having the predetermined pattern of the meshes 5a and the veins 5b to be the texture on the rubber piece 3. The pattern of the texture of the rubber piece 3 is various according to the pattern of the meshed cloth 5 and the size of the pattern is not limited by the rollers.

The second preferred embodiment of the present invention provides a method having the steps as same as the steps of the first preferred embodiment and a further step of removing the meshed cloth 5 from the rubber piece 3 after the step F. The method of removing includes peeling the meshed cloth 5 directly and providing separation agent on the meshed cloth 5 before it is attached on the rubber piece 3 etc. As shown in FIG. 6, after the meshed cloth 5 has been removed, the recesses 3a are left on the surface of the rubber piece 3 to form the texture. Different from the first preferred embodiment providing a convex texture on the surface, the second preferred embodiment provides a concave texture on the surface. The property of the texture relates to the pattern of the pattern and the depths of the recesses 3a and they are controlled by the manufacturers.

It has to be mentioned that the meshed cloth could be a fabric cloth (knit fabric cloth or shuttle fabric cloth), non-woven cloth or other material with meshes and veins. The end product (the rolled rubber piece with or without the meshed cloth) is applied to the handle belt, the conveying belt and so on.

1. A method of forming a texture on a rubber piece, comprising the steps of:
A) preparing a refined rubber piece;
B) preparing a meshed piece having a predetermined pattern;
C) preparing a machine having two rollers thereon;
D) attaching the meshed piece on the rubber piece and heating and rolling the meshed piece and the rubber piece by the rollers of the machine, and
E) vulcanizing the rubber piece.

2. The method as defined in claim 1, further comprising the steps of providing a separation agent on the meshed piece in the step B) and removing the meshed piece from the rubber piece after the step E).

3. The method as defined in claim 1, further comprising the step of removing the meshed piece from the rubber piece after the step E).

4. The method as defined in claim 1, wherein the meshed piece is a fabric cloth.

5. The method as defined in claim 4, wherein the meshed piece is a knit fabric cloth.

6. The method as defined in claim 1, wherein the meshed piece is a shuttle fabric cloth.

7. The method as defined in claim 1, wherein the meshed piece is a non-woven cloth.

8. The method as defined in claim 1, wherein the rubber piece and the meshed piece are heated before they are rolled by the rollers in the step D).

9. The method as defined in claim 1, wherein the rubber piece and the meshed piece are heated and rolled by the rollers at the same time in the step D).

10. A rubber piece having a texture on a surface thereof, comprising a rubber piece body and a meshed piece having meshes and veins, wherein the meshed piece firmly attached on a surface of the rubber piece body such that the surface of the rubber piece body has portions attached with the veins of the meshed piece and has other portions exposed via the meshes.

11. The rubber piece with the texture as defined in claim 10, wherein the meshed piece is a meshed cloth.

11. The rubber piece with the texture as defined in claim 11, wherein the meshed cloth is a fabric cloth.

13. The rubber piece with the texture as defined in claim 12, wherein the fabric cloth is a knit fabric cloth.

14. The rubber piece with the texture as defined in claim 12, wherein the fabric cloth is a shuttle fabric cloth.

15. The rubber piece with the texture as defined in claim 11, wherein the meshed cloth is a non-woven cloth.

16. The rubber piece with the texture as defined in claim 10, wherein the rubber piece body has recesses on the surface at where under the veins of the meshed piece.

17. The rubber piece with the texture as defined in claim 10, wherein the meshed piece is peelable from the rubber piece body.

18. A rubber piece with a texture thereon, comprising a rubber piece body having recesses on a surface thereon to form a predetermined pattern.
